(19) United States
(12) Patent Application Publication
(10) Pub. No.: US 2002/0107786 A1
(43) Pub. Date: Aug. 8, 2002

(54) Peer-to-peer application for online goods trading

(75) Inventors: Noah Lehmann-Haupt, Brookline, MA (US); Raefer C. Gabriel, Cambridge, MA (US)

Correspondence Address: Mary Lou Wakimura, Esq., HAMILTON, BROOK, SMITH & REYNOLDS, P.C., 530 Virginia Road, P.O. Box 9133, Concord, MA, 01742-9133, US

(73) Assignee: TruExchange, Inc., Lexington, MA

(21) Appl. No.: 09/994,373

(22) Filed: Nov. 26, 2001

Related U.S. Application Data
(60) Provisional application No. 60/253,339, filed on Nov. 28, 2000.
(60) Provisional application No. 60/250,093, filed on Nov. 30, 2000.

(51) Int. Cl. G06F 17/60

(52) U.S. Cl. 705/37

(57) ABSTRACT

A peer-to-peer application program is employed in a computer network of users where each user has an established business relationship with at least one other user in the network. The present invention software executed in this network provides an open market trading of goods which takes advantage of the preexisting business relationships.

### RELATED APPLICATIONS

This application claims the benefit of U.S. Provisional Application No. 60/253,339, filed on Nov. 28, 2000, and U.S. Provisional Application No. 60/250,093, filed on Nov. 30, 2000. The entire teachings of the above applications are incorporated herein by reference.

### BACKGROUND OF THE INVENTION

During the past several years, the overall design of application programs has progressed from a stand alone paradigm, to a client-server paradigm, to peer-to-peer. In the stand alone paradigm, the parts of the application program were thought of as running or executing as a single unit. In the client-server paradigm, there are two separately executed “halfs”, (namely the client half and the server half). The server is thought of as local or central to data storage and management. The client is the lighter, remote half which makes data requests to the server. The server is responsive to the client(s) and transmits data to them.

Most recently application programs are following the peer-to-peer design. In that paradigm, a combination of what would have been client and server code forms a hybrid “servent”. Different instances of the servent code are run on the different nodes of a computer network. Each node thus has the capability of acting like a server (i.e., responding to data requests) in some circumstances and a client in other circumstances (i.e., making data requests to other nodes).

### SUMMARY OF THE INVENTION

The present invention utilizes the peer-to-peer paradigm and provides an application program for open market trading of goods. In particular, the present invention takes advantage of existing business relationships among parties and runs/executes an instance of the invention software program at each party's node in a network of computers. The network may be a local area network (LAN), wide area network (WAN), global network (e.g., the Internet) or the like.

A first party transmits a request package from his node to that of a trusted second party with whom there is an existing (and perhaps long standing) business relationship. This transmission is initiated by user interaction, but is then carried out by the processor routine in the node or computer. The request package includes (i) asking price of a good that the first party is trying to sell or a bid of a good that the first party is looking to buy, and (ii) limitations or constraints on the request being made (e.g., number of subsequent nodes the request may be transmitted to).

The second party's node receives the request package and generates rules in accordance with the limitations/constraints included in the request package. The second party user in response prepares and transmits another request package to his business contacts that would likely accommodate the original request (i.e., that of the first party's). In the second party generated request package are (i) a modified asking price or bid of the original request goods (i.e., the original asking price or bid plus a commission for the second party) and (ii) limitations or constraints placed by the first and second parties.

The second party generated request package is received at respective receiver's nodes as designated by the second party and processing continues similarly.

Return responses are likewise transmitted from the receiving party to the sending party and processed accordingly. For example, the second party receives at his node responses from his business contacts in receipt of the second party generated request package. He accepts the best response given the constraints of the original request package from the first party. He in turn transmits a reply to the first party based on the accepted response from the second party's business contacts.

A computer receiving a request package has an inventory of the local goods available for selling and the processor routine modifies the rules dependent on the inventory to reflect seller preferences in product availability. The processor routine in the computer receiving the request package compares the bid to the inventory and attempts to match supply and demand when permitted by the rules. The computer apparatus may also include an interface in a computer sending the request package which allows specification of demand parameters for the desired good and reports back results from a request package traversal of the plurality.

A computer may transmit a confirmation package that traverses the exact node path of an originally confirmed request package. The confirmation package may be transmitted for billing purposes. The constraints may be configured independently via an interface on each computer in the plurality.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic overview of a computer network embodying the present invention;

FIG. 2 is a block diagram of a request package and related rules generated therefrom in the system of FIG. 1;

FIG. 3 is a schematic overview of the software system;

FIG. 4 is a block diagram of a commodity filter employed in the software system of FIG. 3; and

FIG. 5 is a block diagram of a quantity filter employed in the software system of FIG. 3.

### DETAILED DESCRIPTION OF THE INVENTION

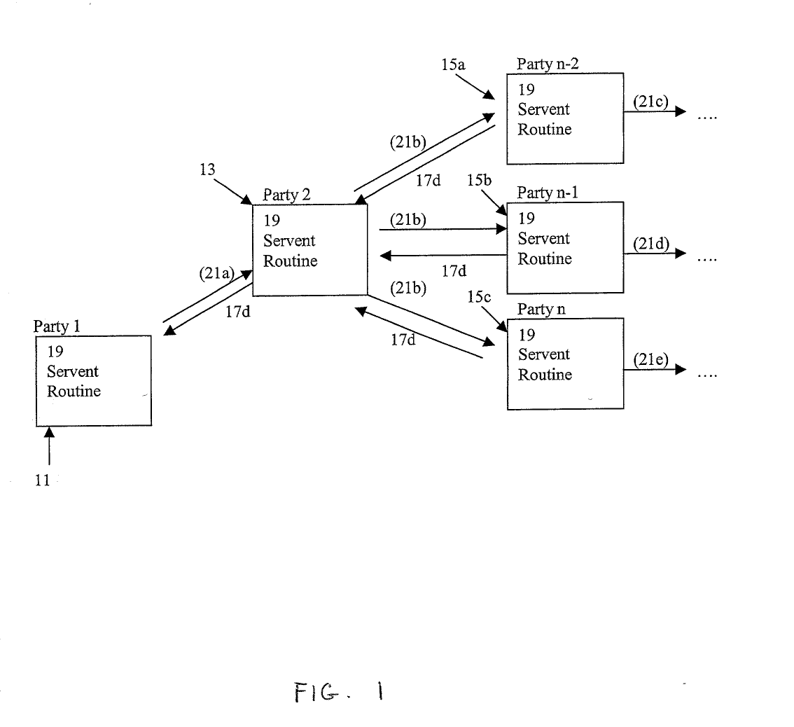

As stated above, Applicants take advantage of the peer-to-peer applications programming paradigm in a computer network of users where each user has an established business relationship with at least one other user in the network. The present invention software 19 (FIG. 1) executed in this network provides an open market trading of goods which takes advantage of the preexisting business relationships. These preexisting business relationships are reflected in configuration of the apparatus to communicate with a corresponding apparatus owned by each of the related parties. Thus the relationships form a logical network operating over a physical network layer for the following request and response communications. This allows each participant in the network to control the flow of information through their systems, and to set and control prices of goods transacted through their systems.

Referring to FIG. 1, a first party transmits a request package 21a from his node 11 to that of a trusted second party with whom there is an existing (and perhaps long standing) business relationship. The request package 21a includes (i) asking price of a good that the first party is trying to sell or a bid of a good that the first party is looking to buy, and (ii) limitations or constraints on the request being made (e.g., number of subsequent nodes the request may be transmitted to).

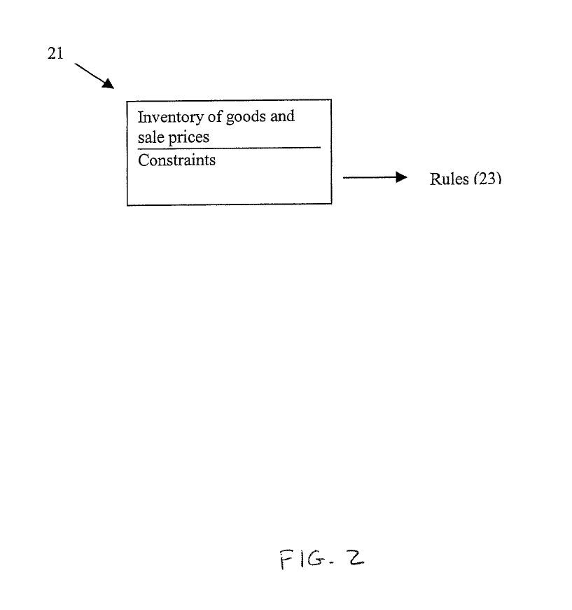

The second party's node 13 receives the request package 21a and generates rules 23 (FIG. 2) in accordance with the limitations/constraints included in the request package. The second party user in response prepares and transmits another request package 21b to his business contacts that would likely accommodate the original request (i.e., that of the first party's). In the second party generated request package 21b are (i) a modified asking price or bid of the original request goods (i.e., the original asking price or bid plus a commission for the second party) and (ii) limitations or constraints placed by the first and second parties.

The generated nodes 23 at each communication level govern the received and next generated request packages 21. As such, the present invention 19 provides dynamic rules-based management of requests.

The second party generated request package 21b is received at respective receiver's nodes 15a, b, c as designated by the second party and processing continues similarly.

Return responses 17a, b, c, d are likewise transmitted from the receiving party to the sending party and processed accordingly. For example, the second party receives at his node responses 17a, b, c from his business contacts in receipt of the second party generated request package 21b. He accepts the best response 17 given the constraints of the original request package 21a from the first party. He in turn transmits a reply 17d to the first party based on the accepted response from the second party's business contacts.

The foregoing communications and rules-based control carry out various trading of goods and in particular enable an open market exchange of goods similar to that explained in U.S. Provisional Application No. 60/253,339, filed on Nov. 28, 2000 the contents of which are incorporated herein by reference in their entirety.

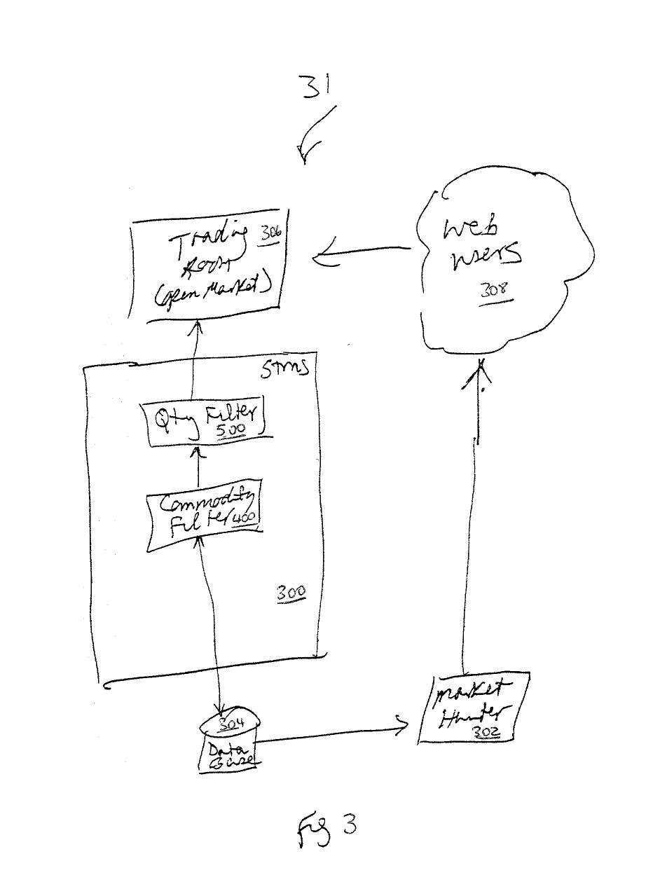

The seller communicates his orders in an interactive manner through a trading room screen view as illustrated in FIG. 3.

Similarly a buyer indicates his bid orders through the trading room screen view of FIG. 3. The system assigns each buyer a unique ID and stores the buyer's bid orders in the database 304 indicating buyer by his ID. The buyer's bid order indicates a kind of goods that the buyer is desiring to purchase. This is unlike online auctions in which the buyer is bidding on a specific individual item. In the buyer's order, the buyer indicates quantity, preferences (if any) of features and attributes of the kinds of goods desired and price that he is willing to pay (termed “bid”). The buyer also states the terms at which he is willing to pay a higher bid price such as with a larger quantity so that a more economical per unit price is obtained or to increase his price as a function of time because the buyer is wanting to complete the transaction by a certain ending date/time and thus willing to increase his bid price. From these buyer stated terms, the system generates rules that are stored in the database 304 along with the buyer's orders.

In the preferred embodiment the database 304 stores the buyer's orders in respective records. For each record there are fields corresponding to the features and aspects and other details of the buyer's order (i.e., quantity, bid price . . . ). The buyer specified rules are stored in the corresponding record or linked thereto, or likewise associated therewith.

Referring to FIG. 3, the end user views a trading room screen 306 which shows for a certain kind of goods, the buyer's orders (bids) and seller's orders (asks) of that kind of goods as stored in records in the database. It is through this screen that transactions of open market trading occur. The screen view is updated by the supporting modules, namely the commodity filter, quantity filter and matching subsystem discussed next.

The commodity filter 400 is at the lowest level of the system 31 and parses users' preferences to generate a custom dynamic marketplace (trading room). This in effect allows end users to view non-identical items as commodities. Market trading rooms are defined only as broad categories based on the least common denominator, so a steel trading room will be distinct from a copper trading room. The commodity filter 400 allows users to configure a custom market from both goods specific attributes (such as item specifications) and market specific attributes (such as delivery location, commitment date, shipment and payment terms). Users' preferences might only partially overlap with one another, which under prior art circumstances would create an inefficiency in the market trading. The commodity filter eliminates that inefficiency and guarantees that at all times a user will see his desired market in the “trading room” screen views. This facilitates better trading, which leads to increased liquidity.

In other words, if a small computer parts retailer is purchasing DIMM memory chips on a distressed inventory trading site and does not care whether he purchases 8 ns or 10 ns modules, he can configure his viewing of the DIMM market with one mouse click in the present invention 31 so that chips of both speeds appear as a single commodity in a true bid-ask market format (the system trading room).

The commodity filter may also parse all goods of a kind based on a “minimum quality” rating system. The system 31 prompts to end user with a numerical “minimum quality” of a particular attribute, and will return matching items that meet that minimum criteria. For example, if a user wishes to specify a bid for a computer processor with a “minimum quality” on the attribute “speed”, he may do so. If he specifies a rating of “100 Mhz”, the system will show him a listing of items that match that criteria, but also items that are an improvement (faster than 100 Mhz). This functionality can be enabled for any attribute that can be ranked on a qualitative scale.

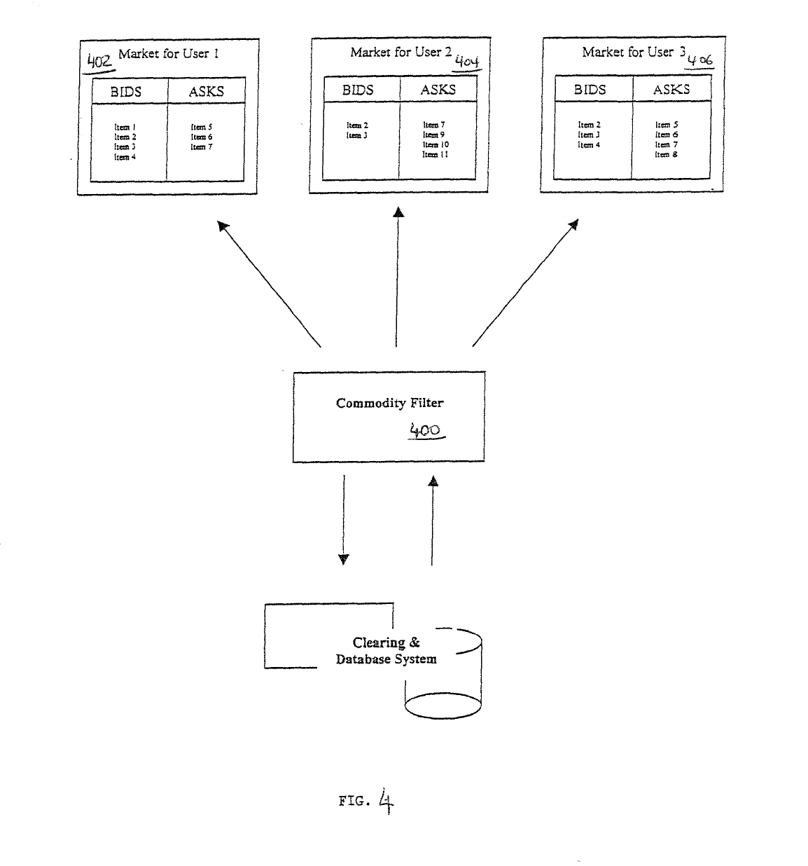

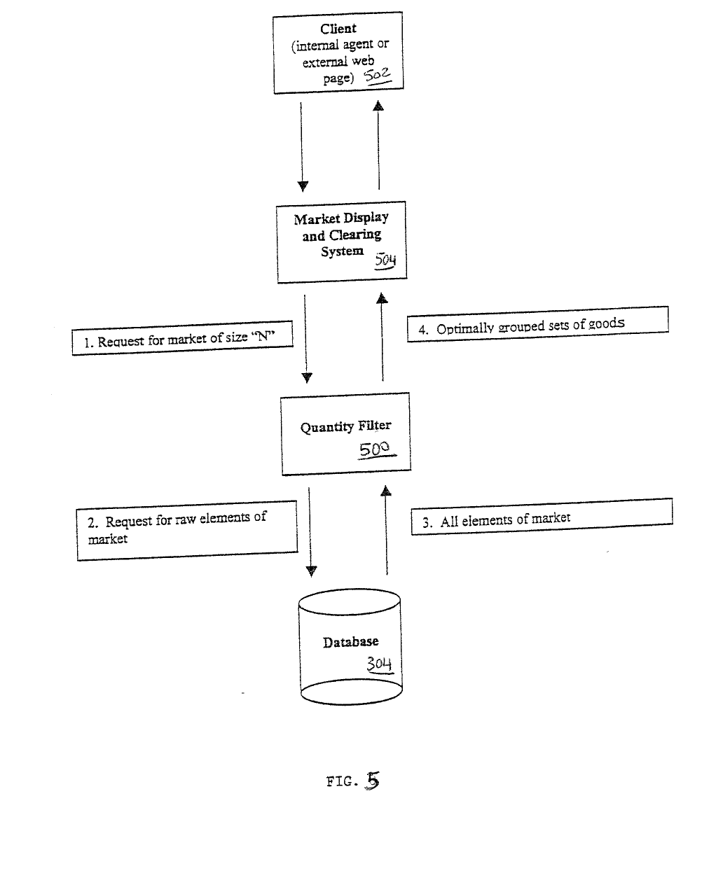

A preferred embodiment of the commodity filter is detailed in FIG. 4 and U.S. Provisional Application No. 60/253,339, filed on Nov. 28, 2000, and U.S. Provisional Application No. 60/250,093, filed on Nov. 30, 2000, the contents of which are incorporated herein by reference in their entirety. Referring to FIG. 5, the Commodity Filter 400 is a system that allows multiple non-fungible items to be traded within an exchange as fungible, depending on the user's preference for certain category-specific criteria. The Commodity Filter dynamically generates a market for each user and allows only those items which the user designates as within his scope of indifference to appear in the market.

A trading area will not necessarily be only for a single item. In general a trading area describes a general type of good, at least more general than a person would usually be interested in buying or selling, based on solely that information. The Commodity Filter allows multiple goods, each with unique characteristics, to coexist within a given trading post.

The user is presented with a list of characteristics at the trading post screen that they may select from pull down menus or radio buttons, depending on the type of characteristic. The searching and matching functions then parse the database entries for the items in the trading post, checking that the attributes meet at least the criteria specified by the user's selections at the trading post screen. Bit strings are used for easy, fast comparison. The result is a fast, easy system that allows the user to specify exactly the characteristics that are most important to him or her, and create a literal market view for items with those characteristics.

The treatment of bids and asks in this system is necessarily different. Bids, by their nature, are placed for an item with a minimum set of criteria. For some people's bids, certain characteristics will be specified, for other bids, those characteristics will be left blank and others will be specified. For asks, in general, all characteristics must be fully specified, as the ask describes a particular item. The market view 402, 404, 406 always corresponds to bids and asks that are compatible (i.e., the bids and asks could be matched to each other at a certain price) Bids are searched in the opposite manner as asks are: the bit strings must be checked to see that the bids are less specific than the parameters the user has selected for the view, whereas asks must be searched to see that the ask characteristics are at least as specific (match at least to the extent that is specified by the user).

Algorithm Detail

The selection process is based on bitstrings that describe the specific skews, or individual characteristics, that any given order can have. The bitstring contains a binary representation of the index into the associated skew value for the individual order. The functions BITWISE_SUBSET and BITWISE_SUPERSET describe the process of either finding a less specific or a more specific set of skew specifications. The numerical representation of all zeros corresponds universally to a setting of no preference, meaning the order does not state any skew variable value for the bid or ask. BITWISE_SUBSET and BITWISE_SUPERSET compare all the skew values for one bid or ask with the current view configuration parameters, ignoring zero valued skews. SUPERSET is used for bid view generation. It compares by looking to see if each of the second arguments index values are at least as specific as the firsts. Thus each value specified in the second argument must hold true in the first value to generate a positive match. SUBSET functions in the opposite manner. The first argument must be MORE specific than the second argument's skew bit set.

A view is generated by retrieving all the possible entries from the database, using a call to the commodity filter 400 with the view settings and the skew parameter database entry as arguments. The commodity filter selection function in turn makes the calls to the BITWISE_SUBSET and BITWISE_SUPERSET functions, and does preprocessing and postprocessing to arrive at a final TRUE or FALSE boolean value describing whether the given bid or ask matches the marketplace view as described by the user's view parameters.

Once the view of the market is determined, a quantity filter 500 handles the number of items in that market. Again, the system is designed to allow the end user at all times to view the optimal market, no matter how many or few of a good that user wishes to transact. A buyer of 10,000 lbs. of hot rolled steel might normally (in prior art systems) find that sellers are only offering lots of 2,000 lbs. However, in the present invention system 31 the quantity filter automatically aggregates five such offers to create a custom virtual offer of 10,000 lbs. specifically for that buyer. Should the buyer accept the offer, the system automatically clears and routes the five separate transactions seamlessly and quickly. On the other hand, if a wheat buyer is only interested in purchasing a small lot of 100 bushels, the invention system displays offers of that size wherever possible. The quantity filter also behaves as an averaging mechanism and allows natural market forces to take effect quickly. As long as the total amount of a group of buyers' bids equals the amount of one or more seller(s) asks, the system will clear the transaction. The breakdown of those bids does not matter to the invention system where the supporting database enables itemized tracking of bids in a group that have been combined by the system.

The preferred embodiment of the quantity filter is detailed in FIG. 5 and U.S. Provisional Application No. 60/253,339, filed on Nov. 28, 2000, and U.S. Provisional Application No. 60/250,093, filed on Nov. 30, 2000, the contents of which are incorporated herein by reference in their entirety. Referring to FIG. 5, the Automatic Quantity Filtering and Aggregation System is a component of a bid-ask market exchange system for quantity-limited trading goods, consumer-oriented or otherwise. The Quantity Filter 500 dynamically generates, through both aggregation and filtering, a bid-ask market for a specified number of items. The system synthetically creates this market by automatically aggregating and filtering bids and asks, across multiple users if necessary, and presenting the optimal sets of orders compatible with the market viewer's desired preferences. This system eases and speeds the purchasing of large numbers of goods in such a system, in which individual orders may be of differing sizes and available quantities from different parties may vary, or be too small to fulfill a desired order size.

The Quantity Filter 500 acts in the middle layer of market generation. It can be activated either directly via user input to a form on a web page 502 or secondhand by an internally-running process acting in the role of the “client.” The system automatically aggregates and filters listings to display a bid/ask market for that number of items. “Aggregate” means the system will group items from multiple users together. If, for example, seller A and seller B have listed two separate asks and the user specifies a market for 2 widgets with the Quantity Filter, then the system will automatically combine seller A's ask with seller B's ask to fit the requirements. If, on the other hand, seller C has three individual (non-lot) widgets for sale, the system will filter out one of them and display the two-unit group. If seller D has an ask for 5 widgets in a single lot, the system will not display the listing because it does not match the criteria of “2 widgets.” The following example displays the functionality of the system:

TABLE 1
The full market for widgets

| BID | | | ASK | | |
|---|---|---|---|---|---|
| | Per-item | | | Per-item | |
| Quantity | Amount | Username | Quantity | Amopunt | Username |
| 1 | 200 | Nlh | 2 | 210 | Nlh |
| 1 | 195 | Fertik | 1 | 215 | Gabriel |
| 3 | 194 | Bwallis | 10 | 225 | Bwallis |
| 2 | 190 | Caustin | 3 | 230 | Fertik |
| 4 | 185 | Gabriel | 4 | 250 | Caustin |

Table 1 displays the full market for widgets. Several users have multiple gids and asks at various prices and various quantities. All entries are considered separate items (no lots).

If the Quantity Filter is activated and a filter of “1” is chosen, the following will be seen as shown in Table 2 below:

TABLE 2
The filtered market for 1 widget

| BID | | | ASK | | |
|---|---|---|---|---|---|
| | Per-item | | | Per-item | |
| Quantity | Amount | Username | Quantity | Amount | Username |
| 1 | 200 | Nlh | 1 | 210 | Nlh |
| 1 | 195 | Fertik | 1 | 215 | Gabriel |
| 1 | 194 | Bwallis | 1 | 225 | Bwallis |
| 1 | 190 | Caustin | 1 | 230 | Fertik |
| 1 | 185 | Gabriel | 1 | 230 | Caustin |

Each listing is filtered to show a true market for a single widget.

TABLE 3
The filtered/aggregated market for 2 widgets

| BID | | | | ASK | | | |
|---|---|---|---|---|---|---|---|
| | | Per-item | | | | Per-item | |
| Quantity | Total | Amount | Username | Quantity | Total | Amount | Username |
| 2 | 395 | 197.5 | Nlh | 2 | 420 | 210 | Nlh |
| | | | Fertik | | | | |
| 2 | 388 | 194 | Bwallis | 2 | 440 | 220 | Gabriel |
| | | | | | | | Bwallis |
| 2 | 380 | 190 | Caustin | 2 | 450 | 225 | Bwallis |
| 2 | 370 | 185 | Gabriel | 2 | 460 | 230 | Fertik |
| | | | | 2 | 500 | 250 | Caustin |

Table 3 shows how the market for 2 widgets would be displayed. Several things have occurred. On the bid side, the bids for 1 widget from Nlh and Fertik have been combined to form a single bid for 2 widgets. The individual prices have been combined and the adjusted per-item price has been calculated and displayed. Bwallis's bid for 3 widgets has been filtered down to 2, Caustin's 2 remains the same, and Gabriel's 4 has been filtered down to 2 as well.

The system does not aggregate items between users unless it has to, since in general it is less desirable to purchase from two people than from one. In the above example, Nlh and Fertik have the items aggregated because a group of two cannot be formed any other way. It should be noted, however, that is would have been possible to group 2 of the 3 from Bwallis together (as is done) and then combine the remaining 1 with an item from Caustin. However that is not done since in that case Bwallis's items are unnecessarily getting split with others. Items are grouped across users if there are too few to form a lot, but not if there are too many.

For consistency, the filtered market for 3 items would appear as shown in Table 4 below:

TABLE 4

| BID | | | | ASK | | | |
|---|---|---|---|---|---|---|---|
| | | Per-item | | | | Per-item | |
| Quantity | Total | Amount | Username | Quantity | Total | Amount | Username |
| 3 | 589 | 196.3 | Nlh | 3 | 635 | 211.7 | Nlh |
| | | | Fertik | | | | Gabriel |
| | | | Bwallis | | | | |
| 3 | 578 | 192.7 | Bwallis | 3 | 675 | 225 | Bwallis |
| | | | Caustin | | | | |
| 3 | 565 | 188.3 | Caustin | 3 | 690 | 230 | Fertik |
| | | | Gabriel | | | | |
| 3 | 555 | 185 | Gabriel | 3 | 750 | 250 | Caustin |

If grouping is selected that contains multiple users, the system will automatically break down the aggregated order and route the individual items to each user.

Algorithm detail

Three equal length vectors of integers, ORDER_AMOUNTS, ORDER_QUANTITIES, and ORDER_IDS are constructed via an appropriate database query for the item and skew parameters that are being filtered for. Two parameters, QUANTITY and ORDER_TYPE are passed from the client interface, specifying the desired number of goods to filter for and whether the filter is being performed for a set of bids or a set of asks (these are two opposing sorting orientations and strategies).

A set of QUANTITY number of ranking vectors is built. These vectors are filled in with values from ORDER_QUANTITIES only when appropriate (when they are possible matches for the desired filtering QUANTITY). Parallel vectors containing the corresponding ORDER_IDS are simultaneously constructed.

Now, a recursive procedure is used to find the unique, optimal index sets, i.e. A set of index numbers that describe a conglomeration of orders that constitute QUANTITY number of items, taken in total. This procedure functions by looking up the list index in the ranking vectors and searching for the smallest price in the ORDER_AMOUNTS vector. The index into this particular item is then added in to the constructed sub-vector, adding the next level of summed goods to the resultant vectors. The result after QUANTITY levels of recursion is a disjoint set of indices that describe uniquely a grouping of goods. The first such grouping will be the most efficient possible grouping in terms of aggregate pricing. The following will be disjoint possible groupings, in decreasing order of aggregate price efficiency.

Referring back to FIG. 3, the matching subsystem in the preferred embodiment is a Symmetric Transaction Matching System (STMS). This subsystem facilitates fast and automatic clearing of the market represented by the displayed trading room. It is unwise to assume that all market participants will want or be able to follow the minute-by-minute movements of the market at all times in the trading room. Furthermore, many participants will not be interested in interacting with the exchange directly and will instead prefer to use their in-house requisitioning or catalog software to handle direct market activities. In that case the STMS maintains an efficient real time market that automatically matches buyers' bids and sellers' asks without the need for a end user to “hit” (a buyer's bid) or “take” (a seller's ask). The system is flexible enough not only to match directly compatible bids and asks (a “natural” match) but allows buyers and sellers to define a range of acceptable prices and expiration times toward clearing trades. As such, the STMS allows for even greater flexibility and liquidity than other systems.

In the preferred embodiment, the STMS employs the rules stored in the database for the sellers' orders and buyers' orders involved in the current trading room. A task manager portion of the STMS executes the rules by tracking and calculating variables (elapsed time, quantitative level of buyers' activity, quantitative level of sellers' activity . . . ) and by arriving at functional results (e.g., after the seller's predefined amount of time, lowering the asking price; or after the buyer's predefined amount of time, increasing the bid price, etc.). As soon as a match exists between a buyer's bid and seller's ask in the trading room, the STMS completes the transaction.

Although price-time rules have been discussed, the rules may further include expiration of an order (seller's or buyer's) after a certain amount of time as predefined by the respective seller/buyer. In the case where the seller's rule is to decrease the asking price to a best bid after a certain amount of time, then the invention system simulates auctioning. An artificial intelligence engine may be employed by the STMS to increase a seller's asking price in a seller's order as a function of buyers' activity and time (e.g., decrease the seller's asking price where low buyer activity exists over seller's specified amount of time. Likewise, on the buyer's orders the artificial intelligence engine may increase the buyer's bid price to the minimum seller's asking price posted in the trading room where no match has been found after a buyer's predetermined amount of time.

Implementation of the preferred embodiment of the STMS is then as follows: The STMS responds as an event-driven system. Events are defined as changes in the rules or status of orders in the system. Rules changes are modifications of an order's properties by its owner. Status changes include indications to purchase or sell an order by a user, the set expiration of an order or the cancellation of an order. Whenever an event occurs in the overall marketplace, notification is sent to the STMS and a comparison between the bids and the asks in that marketplace is made. If any orders are matching in price, the STMS automatically marks the bid as completed, marks the ask as completed, removes the order entries from the list of active marketplace orders, updates the transaction history database with information about the transaction, and sends notification to both of the counterparties that the transaction was completed. The comparison procedure is repeated until orders cannot be matched any more, and the system returns to the waiting state for the next event notification.

With reference to FIG. 3, the Market Hunter portion 302 of the system moves the marketplace beyond the boundaries of the immediate on line trading room. It works alongside the STMS to facilitate a seamless online exchange by interfacing with previously static buy-side requisitioning systems and sell-side catalogs to import bids and asks into the current trading room/marketplace. The displayed bids and asks are thus further updated by the same external systems and the STMS is able to then match and clear those orders—opening up the possibility for a completely automatic marketplace that requires minimal human interaction. In addition, if the system detects a limited number of active buyer bids or seller asks in a particular trading room, the Market Hunter 302 searches the address book portion of the database for appropriate participants (buyers and sellers). The buyers/sellers are indexed in the database by kind of goods usually dealt with, frequency/seasonal participation and the like. The results of the Market Hunter search of the database is a subset of buyers and sellers not currently participating in the displayed trading room. The Market Hunter immediately contacts the subset of buyers and/or sellers and automatically generates RFP's (request for proposals) and/or RFQ's (requests for quotes) in an attempt to draw dormant participants into the current trading room. Their responses may then be automatically entered into the trading room and once again create a custom user specific marketplace.

Details of the preferred embodiment follow below and in U.S. Provisional Application No. 60/253,339, filed on Nov. 28, 2000, and U.S. Provisional Application No. 60/250,093, filed on Nov. 30, 2000, the contents of which are incorporated herein by reference in their entirety.

Referring to FIG. 1 and FIG. 2, in a preferred embodiment, the invention system requires that users only connect directly to other trusted users. A trusted user is another known and identified organization running the invention application 19 (FIG. 1). Before the application 19 connects to a trusted user, that remote user is authenticated in one of several ways (certificate, digital key, etc.). Once a connection has been established, users can send and receive “bids” (offers to buy) and “asks” (offers to sell).

There are three types of users of the system 19:

1) Buyer—this is a user that wishes to purchase goods in the marketplace. Buyers maintain relationships with brokers.

2) Supplier—this is a user that wishes to sell goods in the marketplace.

3) Broker—this is a user that both buys and sells goods.

Initiating orders

Users may at any time issue primary order 21a FIG. 1—bids or asks for items available to be traded in the marketplace. Primary orders 21a are sent to all approved trusted users that are connected to the issuing user. (All users can decide which external parties receive primary orders.) In addition to being broadcast to the marketplace network, users keep a local record of all issued primary orders so that the invention client 19 can accurately update external clients 19 requesting a current marketplace overview.

Relaying orders

Orders 21 (FIG. 2) may also be relayed in the system, following rules 23 (FIG. 2) for how the relaying gets performed. A relayed order 21 is one that is received from an external user and passed along to one or more other users. Relayed orders 21 may be passed along either with identification (so the original sender is identified) or without identification (so the order appears to come from only the immediate relaying user).

The primary user may also specify which parties receive which orders, allowing for sophisticated routing tables to be constructed.

In addition to basic routing, orders 21 may also be specifically marked up (either by a specified percentage of price or by a specific currency value). This effectively allows trusted intermediaries (brokers) to effortlessly pass along order information (thus creating a larger network and increasing the chance of making a buyer-seller match) while still being compensated for their resources (in this case, the relationship).

Hops

Each time an order 21 is passed from a user to another user, its hop count is increased. For example, when an order 21 is sent to an external trusted user, its hop count is 1. If that user relays the order 21 to another set of users, the hop count is 2, and so on. A user issuing a primary order 21a (FIG. 1) may specify as a constraint/limitation the maximum number of hops allowed. Once the specified maximum hop count is reached for an order 21, even if a relaying user allows orders to be relayed, the order 21 will not be relayed.

O-hop partners are defined as

those users in the same organization (useful for trading desks)

complete sharing of information

distributed storage of trading information

can be in physically same network or via high-speed link

Identifying local orders

Orders must be recognizable if they come from yourself to avoid circular order routing or marking up your own orders (if they have been anonymized or are otherwise modified), yet users must not be able to determine the order's originator other than the originator himself. The present invention uses a digital signing process with a nonrepudiated, verifiable digital signature algorithm. In the preferred embodiment, the invention uses DSS (Digital Signature Standard) to generate a message digest via SHA (Secure Hash Algorithm) which is then signed via a DSA (Digital Signature Algorithm) sign process (see Federal Information Processing Standards Publication 186).

The present invention may be employed in a global computer network, such as the Internet, in a private network, or an intranet environment, and a logical network of individual nodes (i.e., the apparatus) may span multiple physical networks.

While this invention has been particularly shown and described with references to preferred embodiments thereof, it will be understood by those skilled in the art that various changes in form and details may be made therein without departing from the scope of the invention encompassed by the appended claims.

What is claimed is:

1. Computer apparatus comprising:
a plurality of loosely coupled computers;
a processor routine executable on each of the computers in the plurality, for generating and transmitting a request package, each request package having (i) an indication of an asking price for a good or a bid for a desired good and (ii) constraints on the request package; and
in a computer receiving the request package, the processor routine generating rules according to the constraints in the received request package, such that the request packages enable open market trading of goods among users of the computers, each user having at least one other user as a prior established business contact.

2. The apparatus as described in claim 1 wherein a computer receiving a request package has an inventory of the local goods available for selling and the processor routine modifies the rules dependent on the inventory to reflect seller preferences in product availability.

3. The apparatus as described in claim 2 wherein the processor routine in the computer receiving the request package compares the bid to the inventory and attempts to match supply and demand when permitted by the rules.

4. The apparatus as described in claim 1 further comprising:
an interface in a computer sending the request package which allows specification of demand parameters for the desired good and reports back results from a request package traversal of the plurality.

5. The apparatus as described in claim 1 wherein a computer transmits a confirmation package that traverses the exact node path of an originally confirmed request package.

6. The apparatus as described in claim 5 wherein the confirmation package is transmitted for billing purposes.

7. The apparatus as described in claim 1 wherein the constraints are configured independently via an interface on each computer in the plurality.

8. Computer apparatus comprising:
a plurality of loosely coupled computers;
means for generating and transmitting a request package on each of the computers in the plurality, each request package having (i) an indication of an asking price for a good or a bid for a desired good and (ii) constraints on the request package; and
in a computer receiving the request package, the means for generating and transmitting generating rules according to the constraints in the received request package, such that the request packages enable open market trading of goods among users of the computers, each user having at least one other user as a prior established business contact.

9. The apparatus as described in claim 8 wherein a computer receiving a request package has an inventory of the local goods available for selling and the means for generating and transmitting modifies the rules dependent on the inventory to reflect seller preferences in product availability.

10. The apparatus as described in claim 9 wherein the means for generating and receiving in the computer receiving the request package compares the bid to the inventory and attempts to match supply and demand when permitted by the rules.

11. The apparatus as described in claim 8 further comprising:
interface means in a computer sending the request package which allows specification of demand parameters for the desired good and reports back results from a request package traversal of the plurality.

12. The apparatus as described in claim 8 wherein a computer transmits a confirmation package that traverses the exact node path of an originally confirmed request package.

13. The apparatus as described in claim 12 wherein the confirmation package is transmitted for billing purposes.

14. The apparatus as described in claim 8 wherein the constraints are configured independently via an interface on each computer in the plurality.

15. A computer implemented method for online goods trading comprising:
in a plurality of loosely coupled computers, generating and transmitting request packages in any one of the computers in the plurality, the request packages having (i) an indication of an asking price for a good or a bid for a desired good and (ii) constraints on the request package; and
generating rules according to the constraints in the received request package in a computer receiving the request package, such that the request packages enable open market trading of goods among users of the computers, each user having at least one other user as a prior established business contact.

16. The method as described in claim 15 wherein a computer receiving a request package has an inventory of the local goods available for selling and the processor routine modifies the rules dependent on the inventory to reflect seller preferences in product availability.

17. The method as described in claim 16 wherein the processor routine in the computer receiving the request package compares the bid to the inventory and attempts to match supply and demand when permitted by the rules.

18. The method as described in claim 15 further comprising:
an interface in a computer sending the request package which allows specification of demand parameters for the desired good and reports back results from a request package traversal of the plurality.

19. The method as described in claim 15 further comprising:
transmitting a confirmation package for billing purposes that traverses the exact node path of an originally confirmed request package.

20. The method as described in claim 15 wherein the constraints are configured independently via an interface on each computer in the plurality.
